(19) United States
(12) Patent Application Publication
(10) Pub. No.: US 2001/0014123 A1
(43) Pub. Date: Aug. 16, 2001

(54) METHOD FOR PROCESSING VIDEO

(76) Inventors: NERY STRASMAN, TEL AVIV (IL); YEHUDA ELMALIACH, ROSH HAAYINH (IL)

Correspondence Address: KENYON & KENYON, ONE BROADWAY, NEW YORK, NY, 10004, US

(21) Appl. No.: 08/868,417

(22) Filed: Jun. 3, 1997

(51) Int. Cl. H04N 7/12

(52) U.S. Cl. 375/240.13

(57) ABSTRACT

The present invention provides a novel method for determining a compression command list of a video signal. The video signal includes a plurality of original frames. The entire video signal is scanned thereby encoding each of the original frames into an Intra-decoded frame, so as to produce an Intra-decoded frame file. It will be noted that this encoding provides information with respect to each of the frames. Then, the Intra-decoded frame file is processed so as to produce an analysis of the activity and complexity of each of the Intra-decoded frames, using the information. Finally, a compression command list is generated. This compression command list determines how and to what extent each of said original is to be compressed, according to the above analysis.

### FIELD OF THE INVENTION

The present invention relates to digital video analysis generally and more particularly to a method for processing video images.

### BACKGROUND OF THE INVENTION

Methods for analyzing and compressing a digital video signal, as well as decompressing the compressed digital code, are known in the art. According to a family of standards, known as Motion Picture Expert Group (MPEG) such as ISO/IEC 11172 (MPEG-1) and ISO/IEC 13818 (MPEG-2), each frame or field of the original video signal, can be compressed into three main types of pictures. It is noted that a picture in MPEG can be either a video frame or a video field. A first type is an Intra-decoded picture (I-frame) which contains all of the information needed to produce a single original picture. A second type is a Predictive picture (P-frame) which includes information for producing an original video frame, based on a previous reference frame. A reference frame is an adjacent I-frame or P-frame. The size of a P-frame is typically smaller than the size of an I-frame. A third type is a Bi-directional predictive (B-frame) which includes information for producing an original video frame, based on either the previous reference frame, the next reference frame or both. The size of a B-frame is typically smaller than the size of a P-frame.

Normally, frames are organized in a Group Of Pictures (GOP) which includes a sequence of P-frames, B-frames and at least one I-frame.

It will be appreciated that the size (S) of the storage unit which contains the compressed digital code, the time period (T) of the entire video signal (movie) and the frame rate (N) which is the number of frames in a given time unit are major factors in determining the average amount of storage area (M) which is provided for each frame, wherein:

$$M = \frac{S}{T \times N} .$$

A main task of methods for video signal pre-compression analysis is to determine the optimal distribution of storage area among the plurality of frames to be compressed, so as to provide a list of commands which assigns a type of frame (I, P or B) to each of the original frames of the video signal.

Reference is made to FIG. 1 which is a schematic illustration of a prior art method for determining a compression command list.

In step 10 the entire video signal is scanned, frame by frame, so as to analyze the activity and complexity of the entire frame sequence, thereby producing an original frames analysis.

Then, a compression command list is generated (step 12) from the original frame analysis. The compression command list determines how and to what extent each one of the frames of the video signal, is to be compressed.

Finally, the entire video signal is scanned again (step 104) and each of the frames is encoded according to the compression command list.

Each of the original frames includes a substantial amount of information which means that analyzing a few minutes of video requires several Giga-bytes of memory on board combined with very powerful processing capacity. Thus, these methods require high power, high capacity computer systems, for processing a video signal in reasonable time.

It will be appreciated that these methods are not executed on micro-computer systems, such as IBM-PC and APPLE-MAC, a number of reasons, such as incapability of containing more than a few frames at once, incapability of analyzing more than a few frames at reasonable times, extremely low data transfer rates compared to dedicated systems, and the like.

### SUMMARY OF THE PRESENT INVENTION

It is an object of the present invention to provide a novel method for analyzing a video signal.

In accordance with the present invention there is thus provided a method for determining a compression command list of a video signal, which includes a plurality of original frames. The method includes the steps of:

scanning the entire video signal, thereby encoding each the original frames into an Intra-decoded frame, so as to produce an Intra-decoded frame file;

processing the Intra-decoded frame file thereby analyzing the activity and complexity of each of the Intra-decoded frames;

generating a compression command list which determines how and to what extent each of the original is to be compressed, according to the above analysis.

The method of the present invention may further include the step of encoding each of the original frames according to the compression command list.

According to one aspect of the invention, the step of processing the Intra-decoded frame file includes the step of determining a motion characteristic for each of the Intra-decoded frames.

According to another aspect of the invention, the step of processing the Intra-decoded frame file includes the step of determining an energy characteristic for each of the Intra-decoded frames.

Accordingly, the step of processing the Intra-decoded frame file may further include the step of determining for each of the Intra-decoded frames an activity value from the energy value and the motion value.

According to a further aspect of the present invention, the step of processing the Intra-decoded frame file further includes the step of calculating an average energy value, a minimum energy value and a maximum energy value from the energy values.

In accordance with yet another aspect of the invention, the step of processing the Intra-decoded frame file may further include the step of allocating a bit-rate for each of the original frames according to the energy value, the average energy value, the minimum energy value and the maximum energy value.

### BRIEF DESCRIPTION OF THE DRAWINGS

The present invention will be understood and appreciated more fully from the following detailed description taken in conjunction with the drawings in which:

FIG. 1 is a schematic illustration of a prior art method for determining a compression command list;

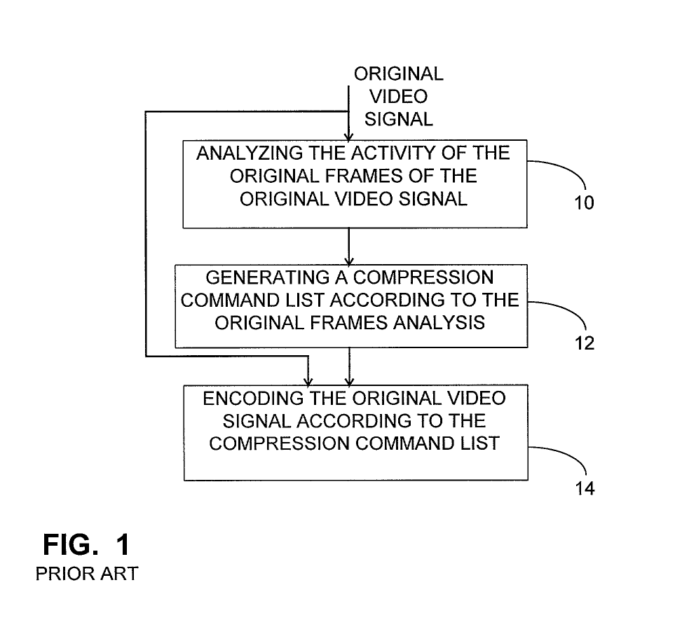

FIG. 2 is a schematic illustration of a method for determining a compression command list, operative according to an embodiment of the present invention;

FIG. 3 is a schematic illustration of the frames of a video signal, an I-frame file and a compressed final file; and

FIG. 4 is a schematic illustration of a step of the method of FIG. 2 for analyzing an initial I-frame file.

### DETAILED DESCRIPTION OF PREFERRED EMBODIMENTS

The method of the present invention overcomes the disadvantages of the prior art by providing a first pass of the original video clip which converts each of the original frames of the video clip into an I-frame and further analyzes the I-frame instead of processing the original frame. According to the invention, the original frames are not analyzed.

Compressing an original frame into an I-frame is usually performed in real time, and provides a plurality of data relating to various characteristics of image activity. The method of the invention utilizes this data to produce a compression command list for compressing the original video clip in a second pass.

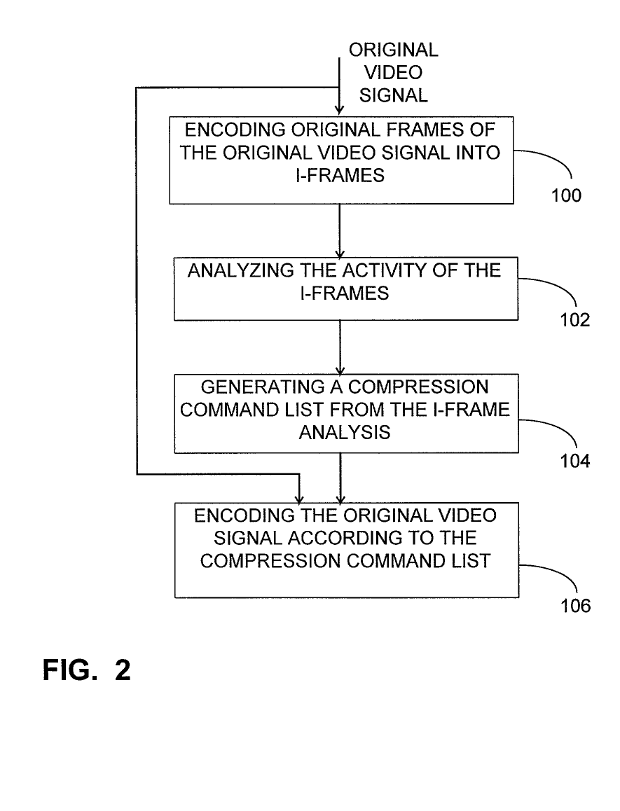

Reference is now made to FIG. 2 which is a schematic illustration of a method for determining a compression command list, operative according to an embodiment of the present invention.

In step 100, the entire video signal is scanned, frame by frame. Each of the original video frames is encoded into an I-frame, so as to produce a file which includes the entire video signal in the form of I-frames.

In step 102, the I-frame file is analyzed, so as to determine the activity and complexity of each of the I-frames, which correspond to the activity and complexity of the respective original video frames of the video signal. Accordingly , an I-frame analysis is produced.

In step 104, a compression command list is generated according to the analysis of the I-frame file. The compression command list determines how and to what extent each one of the original frames of the video signal, is to be compressed.

In step 106, the entire video signal is scanned, frame by frame and each of the original frames is encoded according to the compression command list either to an I-frame, a P-frame, a B-frame or, according to the compression command list.

It will be noted that an I-frame encoded from an original frame in step 100 is not necessarily identical to an I-frame encoded from the same original frame in step 106.

It will be appreciated that normally, the size of an I-frame is significantly smaller than the size of the respective original frame. Thus, processing and analyzing an I-frame requires significantly less computation power as well as a significantly reduced memory area on board.

Furthermore, since the size of the I-frame file is significantly smaller than the size of the original video signal, the storage unit which is required during the analysis process is significantly smaller than the one which is required according to prior art methods.

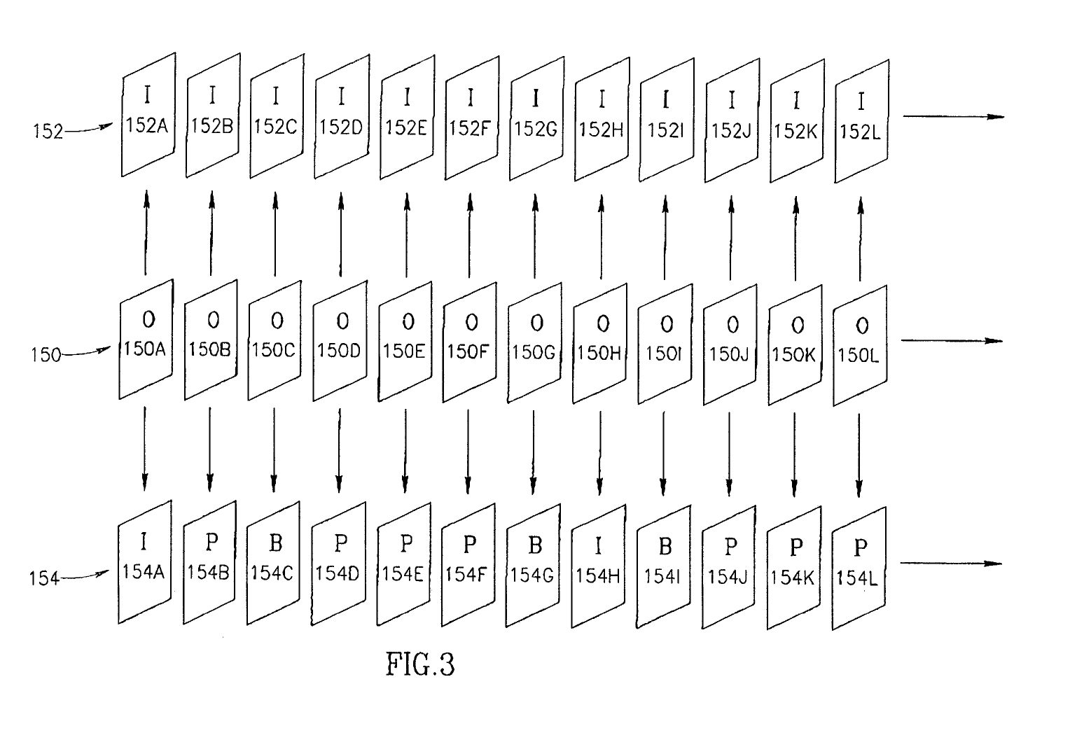

Reference is now made to FIG. 3 which is a schematic illustration of the frames of a video signal, an I-frame file and a compressed final file. Frames 150A-150L represent the frames of an original video signal which are received from a non-compressed video source, which can be a video camera, a video cassette, and the like. Frames 152A-152L represent I-frames which are generated according to the method of the invention from the first pass (step 100). Frames 154A-154L represent the final compressed file which is produced according to the analysis of frames 152A-152L wherein frames 154A and 154H are I-frames, frames 154D, 154G, 154J and 154L are P-frames and frames 154B, 154C, 154E, 154F, 1541 and 154K are B-frames.

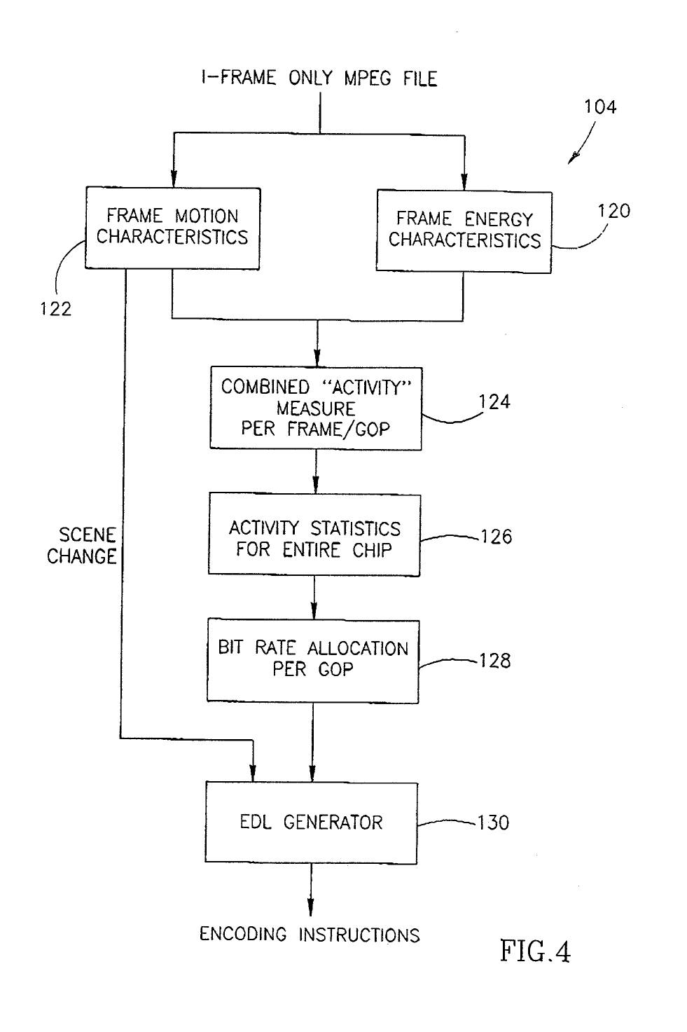

Reference is now made to FIG. 4 which is a schematic illustration of step 104 of FIG. 2 for analyzing an initial I-frame file.

In step 120, the “Energy” characteristic of a given I-frame is measured and determined. The frame energy, in general, is related to the diversity in the frame and provides information as to how difficult it would be to compress this frame as an I-frame. A frame which includes many details may have a higher “Energy” characteristic than a frame which includes few details.

In step 122 the “Motion” characteristic of a given I-frame is measured and determined. The motion characteristic is related to the extent of difference between a given frame and the previous frame. For example, movement, a scene change, and the like are likely to increase the motion characteristic.

In step 124, the “Energy” and “Motion” characteristics are combined together so as to produce an “Activity” parameter of the given I-frame. In this step, the average, minimum and maximum values of the activity are calculated.

In step 126, an activity statistics for the entire video signal is produced.

In step 127, an initial GOP size is determined, usually according to the encoder in use. It will be noted that this GOP size may change with respect to the complexity of the video signal In step 128, the bit rate allocation for each GOP is determined.

In step 130 is generating compression command list for encoding the original video signal.

Step 120 can be implemented in many ways. One way relates to a parameter called the quantizer scale, which determines the compression extent. Normally, each frame includes a plurality of slices wherein each slice includes a slice header and a plurality of macro blocks. Each macro-block includes a macro-block header and four luminance blocks and a few chrominance blocks. Each block is a matrix of 8×8 pixels. The blocks are generally processed according to parameter values determined in the last slice header or the last macro-block header. Generally, a slice header includes a plurality of default parameter values, which are used so long as a macro-block header which follows doesn't provide new values for these parameters. One of these parameters is the quantizer scale.

According to MPEG compression methods, the quantizer scale value can be predetermined as fixed whereby the number chosen will preferably be as small as possible, within the bit-rate limitations. It can also be determined dynamicaly in each of the macro-block headers, whereby the compression mechanism provides the quantizer scale value. It will be appreciated that the a slice header quantizer scale value can be predicted according to a previous slice header quantizer scale value, in the same frame.

According to one aspect of the present implementation, the analysis system accesses each of the slice headers and the macro-block headers of a given frame, retrieves their quantizer scale values and provides them as a characteristic for the “energy” of the frame.

According to another aspect of the present implementation, the analysis system accesses each of the slice headers of a given frame, retrieves their average quantizer scale values and provides them as a characteristic for the “energy” of the frame.

A basic block is a matrix of 8×8 pixels. According to MPEG methods, a Discrete Cosine Transform (DCT) is applied to each block which provides a plurality of coefficients that characterize the diversity of the block. It will be appreciated that in the DCT matrix, the 0,0 coefficient is called the DC coefficient and the rest of the matrix coefficients are called the AC coefficients. According to yet a further aspect of the invention, the sum of the DCT-AC weighted coefficients in a given frame provides a relatively good measure of the “Energy” of the frame.

The DCT-AC weighted coefficients can be derived from the DCT-AC coefficients, by dividing each of them by the corresponding MPEG standards' default quantizer matrices coefficient. It will be noted that any other logic or experience based weighing method is applicable to produce the DCT-AC weighted coefficients.

According to yet another aspect of the invention, the quantizer scale is set before the first pass (step 150), then the step of primary conversion of the video signal into I-frames, produces I-frames wherein each I-frame requires a different volume size, according to the complexity of the corresponding original frame. Thus, the size of a given I-frame determines the “Energy” characteristic therefor.

Step 122 can also be implemented in many ways. For example, the MPEG standard relates separately to the chromaticity and to the intensity of a given pixel, thereby generating two chromaticity pictures and an intensity picture.

According to the present example, the “Motion” characteristic between two adjacent I-frames is determined by subtracting a predetermined matrix of the first I-frame from the respective predetermined matrix of the second I-frame, thereby producing a difference matrix whose variance is then calculated. Either the variance of the color difference matrices, the variance of the intensity matrix or their combination can be used to determine the “Motion” characteristic.

In step 126, the average activity value is assigned to the average bit-rate value, the maximum activity value is assigned to a predetermined maximum bit-rate value and the minimum activity value is assigned to a predetermined minimum bit-rate value. According to the invention, the activity values can be slightly adapted to conform with the respective bit-rate values.

Compressing video signal into l-frames can be performed using a variety of video compression cards such as the SUPERSUITE video compression card, manufactured and sold by OPTIBASE Inc. of San Jose, Calif. and the BROADWAY video compression card, manufactured and sold by DATA-TRANSLATION Inc. of Marlboro Mass.

It will be noted that the above method is applicable to video standards which are similar to MPEG such as ISO/IEC H.261 and H.263, as well as different motion JPEG methods.

It will be appreciated by persons skilled in the art that the present invention is not limited to what has been particularly shown and described hereinabove. Rather the scope of the present invention is defined only by the claims which follow.

1. A method for determining a compression command sequece of a video signal, the video signal comprising a plurality of original frames, the method comprising the steps of:
A. scanning said entire video signal, thereby encoding each said original frames into an Intra-decoded frame, so as to produce an Intra-decoded frame file;
B. processing said Intra-decoded frame file thereby analyzing the activity and complexity of each of said Intra-decoded frames;
C. generating a compression command list which determines how and to what extent each of said original is to be compressed, according to the analysis of step B.

2. A method according to claim 1 further comprising the step of encoding each said original frames according to said compression command list.

3. A method according to claim 1 wherein said step B comprises the step of determining a motion characteristic for each of said Intra-decoded frames.

4. A method according to claim 1 wherein said step B comprises the step of determining an energy characteristic for each of said Intra-decoded frames.

5. A method according to claims 3 and 4 wherein said step B further comprises the step of determining for each said Intra-decoded frames an activity value from said energy value and said motion value.

6. A method according to claim 5 wherein said step B comprises the step of calculating an average energy value, a minimum energy value and a maximum energy value from said energy values.

7. A method according to claim 6 wherein said step B comprises the step of allocating a bit-rate for each of said original frames according to said energy value, said average energy value, said minimum energy value and said maximum energy value.
